(19) United States
(12) Patent Application Publication
(10) Pub. No.: US 2007/0205107 A1
(43) Pub. Date: Sep. 6, 2007

(54) Electrodialysis Compartment and Cell, Method of Mounting an Electrodialyser, and Electrodialyser

(75) Inventor: Luc Botte, Rosignano-Solvay (LI) (IT)

Correspondence Address: OBLON, SPIVAK, MCCLELLAND, MAIER & NEUSTADT, P.C., 1940 DUKE STREET, ALEXANDRIA, VA, 22314, US

(73) Assignee: SOLVAY (SOCIETE ANONYME), Brussels (BE)

(21) Appl. No.: 10/592,676

(22) PCT Filed: Mar. 7, 2005
(86) PCT No.: PCT/EP05/51004

§ 371 Date: Jan. 12, 2007

(30) Foreign Application Priority Data
Mar. 16, 2004 (FR) 04 02701

(51) Int. Cl. B01D 61/42

(52) U.S. Cl. 204/518; 204/627

(57) ABSTRACT

A compartment for an electrodialysis cell, bounded by two ion-permselective membranes located on either side of a separator frame. The separator frame is formed from the assembly of at least two layers to provide electrolyte feed channels between the at least two layers.

Electrodialysers are well known in the technical field, especially for the production of soft water starting from brackish water or for the production of aqueous sodium hydroxide solutions starting from aqueous solutions of sodium salts such as, for example, sodium chloride, sodium carbonate or sodium sulphate. They are formed by assembling, between two end electrodes, a number of identical electrodialysis cells. An electrodialysis cell consists of two or more compartments bounded between two ion-permselective membranes. To maintain a sufficient space between the membranes, in order to allow the circulation of electrolytes in contact with the membranes, the cells are also provided with separator frames. The separator frames, drilled with holes in order to allow the electrolytes to flow from one cell to another, are placed between the membranes over their outer perimeter (Techniques de I'Ingéngieur, Chimie-Génie chimique, 3-1988, J2840, pages 1-21). The juxtaposition of the holes made in the separator frames and in the membranes therefore forms distributor ducts constituting the electrolyte circuits in the electrodialyser. Moreover, the separator frames must be provided with means that allow the electrolytes coming from the tubular ducts to be distributed over the surface of the membranes inside the compartment in the most uniform manner possible.

Industrial electrodialysers usually comprise a large number of successive electrodialysis cells between the two end electrodes, this number possibly reaching or even exceeding one hundred. The objective is therefore to use thin membranes and thin separator frames so that the distance separating the two electrodes is short. Customarily, the thickness of the separator frames is barely a few millimetres, generally less than 5 mm. It rarely exceeds 3 mm. The thickness of the membranes is customarily less than 1 mm and rarely exceeds 0.3 mm, or even 0.2 mm. Moreover, the area of the membranes may reach or even exceed 1 m². This high area/thickness ratio of the compartments makes it complicated for the electrolytes coming from the tubular ducts to be uniformly distributed over the surface of the membranes inside the compartments.

It is known to provide, in the thickness of the separator frames, very fine channels starting from the tubular ducts and ending in the compartment. To guarantee good distribution uniformity, the dimensions of the channels must be very accurately controlled, making them difficult to produce with a thickness of the order of few millimetres.

The object of the invention is to provide improved electrodialysis cells in which the electrolytes are distributed in a simple and precise manner.

Consequently, the invention relates to a compartment for an electrodialysis cell, bounded by two ion-permselective membranes on either side of a separator frame, the compartment being characterized in that the separator frame is formed from the assembly of at least two layers so as to leave, between the said layers, electrolyte feed channels coming from the circulation orifices into the internal volume of the compartment, at least one portion of the walls of the feed channels being formed by the internal surfaces of the two layers.

In the electrodialysis cell compartment according to the invention the separator frame is rectangular and defines a rectangular internal volume. At least one of its four sides is drilled with at least one hole in the direction transverse to the opening of the frame. This hole constitutes a section of a duct for conveying electrolytes when several similar frames are joined together with membranes to form an electrodialyser. The side that is drilled with the hole may be a horizontal side or a vertical side of the frame. It is generally a horizontal side, which may be the top side or the bottom side of the frame. As a variant, both horizontal sides and/or both vertical sides of the frame are drilled with holes.

In practice, the top and bottom sides of the separator frame are drilled with several different holes that are intended to form, by superposition, separate tubular ducts for circulation of separate electrolytes. Advantageously, these holes are drilled symmetrically and the ducts that they constitute are advantageously used so that a single separator frame model can be used for supplying the various types of compartments with different electrolytes, by rotating the frame or turning it upside down. For example, it will be possible for a separator frame drilled with four symmetrical holes on its top and bottom sides, by bringing the first top hole and the penultimate bottom hole into contact with the compartment defined by the frame, and by turning it upside down and rotating it through 180°, to provide four types of compartment that may be coursed by four different electrolytes.

According to the invention, the separator frame is formed from the assembly of at least two layers so as to leave, between the said layers, electrolyte feed channels coming from the circulation orifices into the internal volume of the compartment, at least one portion of the walls of the feed channels being formed by the internal surfaces of the two layers.

Advantageously, at least one layer is recessed over a portion of its thickness in order to provide the feed channels after assembly.

In a preferred embodiment of the compartment according to the invention, the separator frame comprises a central layer between the two layers, the central layer being recessed over its entire thickness in order to provide the feed channels.

In this embodiment, the recess may be produced very simply by placing the central layer on a flat surface and cutting the channel into it by means of any suitable cutting tool such as, for example, a blanking die. Since the cut is made right through, any fluctuations in the thickness of the channel are avoided since the thickness corresponds exactly to the thickness of the central layer. The central layer, recessed by cutting, constitutes both lateral faces of the channel By joining the outer layers on either side of the central layer, the channel is closed on the remaining two faces. Because the membranes are not in direct contact with the intensive flux of electrolyte in the feed channels, the risk of damaging the membranes near the channels is reduced. The assembly operation may comprise only a simple contacting operation, assembly being made fluidtight by clamping when the separator flame is placed in the electrodialyser. Advantageously, the assembly may include a step of fastening the outer layers to the central layer. Preferably, they are fastened by adhesive bonding or by welding. It is recommended that the welding be carried out by means of laser techniques.

The “outer” and central layers of the separator frame may be made of any rigid or flexible material that is capable of withstanding the chemical and thermal environment normally prevailing in the electrodialysis cells. These may for example be made of polyvinyl chloride, polyethylene or polypropylene, rigid polypropylene being preferred.

However, it is preferred that the central layer be made of a material more flexible than the outer layers. In this embodiment, the central layer advantageously has a Shore A hardness varying from 50 to 85, preferably from 60 to 65. It may for example be obtained from various elastomeric substances. It then constitutes a diffuser joint

In a recommended embodiment of the compartment according to the invention, the central layer has a smaller thickness than each of the outer layers. Separator frames consisting of a central layer having a thickness of between 0.5 and 0.7 mm and outer layers having a thickness of between 0.9 and 1.1 mm are for example very suitable.

In the electrodialysis cell compartment according to the invention, the ion-permselective membranes may be anionic, cationic or bipolar. Very good results have been obtained using MORGANE® AW (anionic) and CRA (cationic) membranes having a thickness of approximately 150 μm. As bipolar membrane, it is possible to use for example a membrane obtained by juxtaposition, carried out under the conditions described in the document WO 01/79335, a cationic MORGANE CDS membrane (150 μm) with an anionic MORGANE ADP membrane (50 μm).

In a recommended embodiment of the compartment according to the invention, the compartment comprises a lattice essentially filling the entire internal volume of the compartment, bounded by the faces of the membranes and the inner faces of the separator frames.

In a preferred variant of this embodiment, the lattice comprises a thick wide-meshed layer located between two thin fine-meshed layers. Advantageously, the thick layer has a thickness at least twice the thickness of each thin layer. Preferably this thickness ratio does not exceed 5. For example, it is possible to use a lattice whose thick layer has a thickness of between 1 and 2 mm and two thin layers having a thickness of between 0.4 and 0.6 mm.

In an advantageous version of this variant, the diameter of the wide meshes is at least twice that of the fine meshes. Preferably, this diameter ratio does not exceed 5. Again, purely by way of example, lattices having fine meshes of between 2 and 3 mm and wide meshes with diameters between 5 and 10 mm give good results.

The lattice may be made of any rigid or flexible material that can withstand the chemical and thermal environment normally prevailing in the electrodialyser cells. It is preferred to make it from a rigid material, for example rigid polyvinyl chloride, rigid polyethylene or rigid polypropylene. Rigid polypropylene is preferred.

The lattice and the separator frame may be integral and manufactured as a single part. However, it is recommended that the lattice not be integral with the frame. This makes it possible for those parts that are in good working order to be recovered independently during the servicing of the electrodialysers.

The electrodialysers are formed by assembling, between two end electrodes, a number of identical electrodialysis cells, one electrodialysis cell consisting of two or more compartments. For example, the cells of the electrodialysers for the coproduction of sodium hydroxide and hydrochloric acid comprise three compartments that are coursed by the sodium chloride solution, the hydrochloric acid and the sodium hydroxide, respectively.

The invention therefore also relates to an electrodialysis cell comprising at least one compartment according to the invention. It also relates to an electrodialyser comprising at least one such cell.

Since the compartment, the cell and the electrodialyser according to the invention are obtained by joining several elements together, particular attention must be paid to the method of assembly used.

Consequently, the invention also relates to a method for mounting an electrodialyser comprising a plurality of electrodialysis cells, in which, in a first step, subassemblies each consisting of the assembly of at least two cells are formed separately and, in a second step, the said subassemblies are joined together between end walls in order to form the electrodialyser.

In the method according to the invention, it is preferred to work horizontally, that is to say by placing the first constituent component—which is usually a separator frame—on a flat surface and superposing thereon, in succession, all the components constituting a cell (membranes, separator frames, lattices).

The assembly by superposition is then continued with the constituent components of a second cell, and then optionally continued until a subassembly comprising the desired number of cells has been obtained Advantageously, this number may be at least 3. It is recommended that it not exceed 50. Numbers ranging from 5 to 20 are preferred.

When the separator frames are themselves formed by juxtaposition of various layers, these layers advantageously are juxtaposed by superposition during formation of the subassemblies.

The operation is then started all over again in order to form the number of subassemblies needed for producing the complete electrodialyser.

In order for the electrodialyser to operate correctly, it is essential that the channels for distributing the electrolytes in the compartments themselves be properly fluidtight. It is recommended that each subassembly be tested separately for fluidtightness, for example using hydraulic or pneumatic means.

In the second step of the method according to the invention, what remains to be done is to juxtapose the number of subassemblies constituting the electrodialyser between the two end boxes and to keep them in position by suitable fastening means. In certain cases, it is recommend to provide seals between the subassemblies and to take measures to ensure that the fastening means cause the subassemblies to be compressed one against another so as to make them even more fluidtight.

There are several advantages in the method according to the invention of dividing the assembly process into two substeps. This is because it allows the execution of the two steps to be entrusted to different personnel, possibly even in different environments or even different geographical locations. Joining the subassemblies together requires a great deal of attention and great precision, in a propitious environment. However, the juxtaposition of the subassemblies, which are less numerous, be accomplished more easily in an industrial environment. Moreover, the electrodialysers for sodium hydroxide production, which are provided with separator frames according to the invention, consist of the superposition of more than 1500 components, the slightest assembly error, for example an inversion, compromising the operation of the entire electrodialyser. It has proved to be more difficult for operators to maintain vigilance over the entire duration of the mounting operation and during the assembly of a subassembly. Finally, two-step assembly allows each subassembly to be tested separately and a more reliable electrodialyser is obtained.

The method according to the invention is also suitable for assembling any electrolytic device comprising a large number of identical cells involving ion exchange membranes. In particular it is suitable for assembling fuel cells comprising ion exchange membranes.

The method according to the invention is particularly suitable for assembling electrodialysers comprising at least one compartment according to the invention.

In a preferred way of implementing the method according to the invention, the subassemblies are packaged after they have been formed, then unpacked before being joined together. This has the advantage that the subassemblies formed are better preserved and easier to transport. The package is advantageously made from very thin metal foil, for example aluminium foil, coated with a layer of a thermoplastic allowing easy welding. In certain cases, it is recommended to place, in the package, means capable of containing a substance that further improves the preservation of the subassembly and in particular the preservation of the ion exchange membranes that it contains. For example, a quantity of an absorbent substance can be placed inside the package, such as blotting paper impregnated with a solution intended to maintain the humidity.

In a variant of this method of implementation, the packaging operation is carried out in a vacuum.

A moderate level of vacuum, for example corresponding to an under pressure of at least 0.1 bar, may suffice. Vacuum packaging improves the preservation of the membranes. Moreover, because of the vacuum the package becomes considerably more rigid, it being more difficult for the various layers to slide over one another. This difference in rigidity allows the quality of the package to be rapidly checked during use. It also enables them to be handled more easily.

In order to make this handling easier, it is recommended to place transport straps beneath each subassembly in the package. The straps are therefore packaged with the subassembly. When the package is opened for use, the straps already present provide a convenient gripping means, for example by attaching them, after unpackaging them, to a transport frame via any suitable conventional fastening device. The subassembly may then be handled for juxtaposing it with other similar subassemblies so as to form the electrodialyser, while reducing the risk of a relative displacement of the various constituent layers during this handling operation.

After the subassembly has been juxtaposed with other subassemblies, it generally loses its individuality, nothing distinguishing it from its neighbours.

However, in a preferred variant of the method according to the invention, this includes an additional step, intermediate between the first and second steps, consisting in forming intermediate modules consisting of one or more subassemblies, the constituent components of these intermediate modules being fastened together by using fastening means. These fastening means comprise, purely by way of example, two rigid frames, made of metal or plastic, for example polypropylene, and ties enclosing the subassembly or subassemblies forming the intermediate module. The intermediate module is then joined as such, while maintaining its individuality, to other intermediate modules in order to form the electrodialyser. The electrodialyser obtained by this variant has the advantage of allowing rapid substitution, within the electrodialyser, of an intermediate module for another one, for example during a maintenance operation following the detection of a localized malfunction in one of the intermediate modules.

Consequently, the invention also relates to an electrodialyser that can be obtained by the method according to the invention which comprises a plurality of electrodialysis cells grouped into modules and fastening means intended to fasten each module together, so as to allow modules to be easily substituted after the electrodialyser has been assembled.

Particular features and details of the invention will become apparent from the following description of the appended figures.

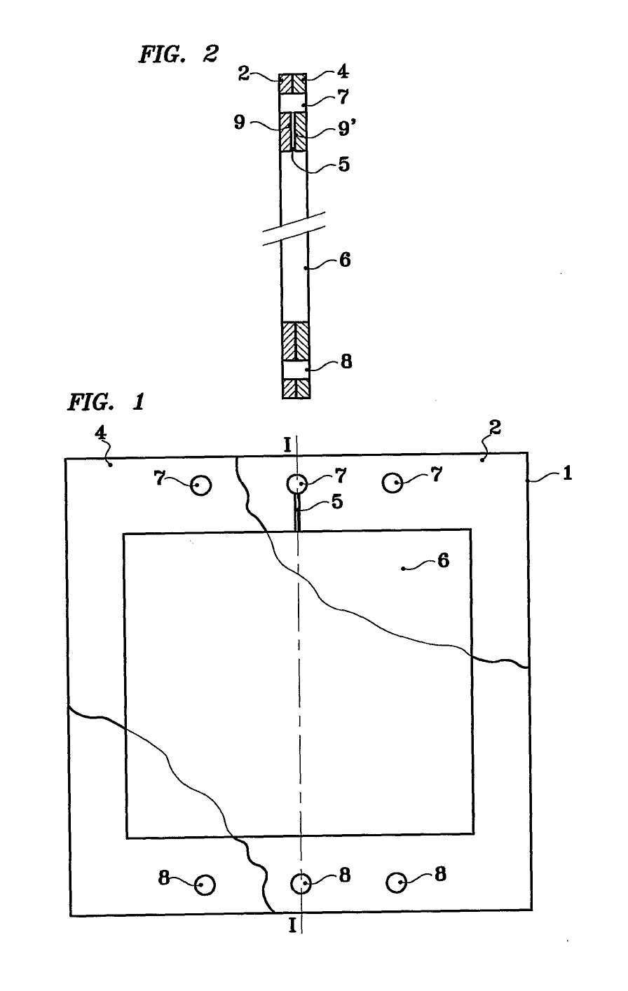

FIG. 1 is a front view, with partial cutaway, of a separator frame according to the invention, formed from the assembly of two layers.

FIG. 2 is a vertical cross-sectional view on the plane I-I of FIG. 1.

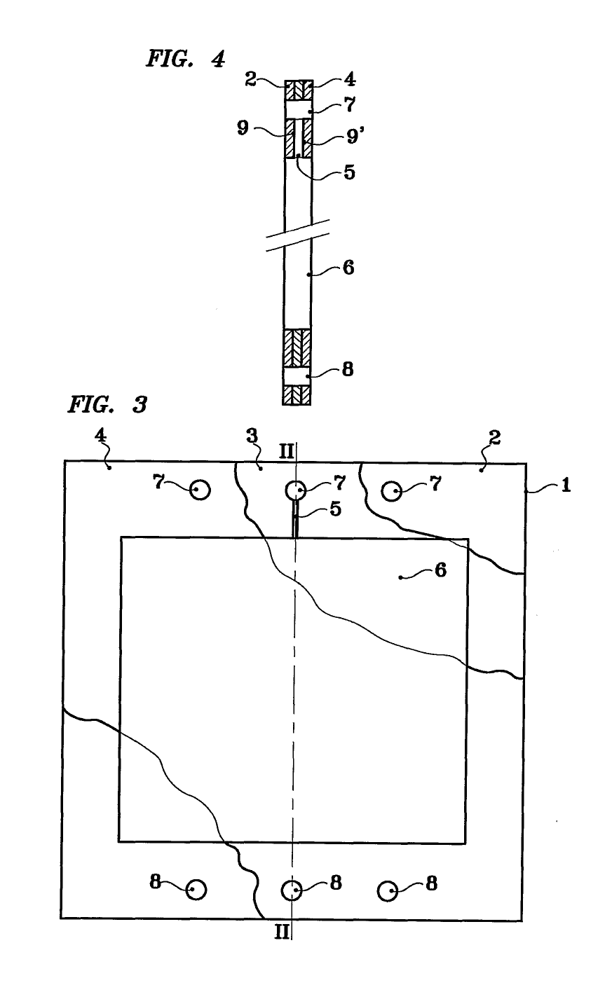

FIG. 3 is a front view, with partial cutaway, of an alternative embodiment of the separator frame according to the invention, formed from the assembly of three layers.

FIG. 4 is a vertical cross-sectional view on the plane II-II of FIG. 3.

In these figures, the same reference notations denote identical elements.

The separator frame (1) shown in FIG. 1 consists of two assembled layers (2), (4). The layers are drilled with inlet holes (7) and with outlet holes (8) for circulation of the electrolytes. The two layers (2), (4) are recessed over a portion of their thickness in order to provide the circulation channel (5) that brings the hole (7) into communication with the internal volume (6) of the separator frame. A second, similar channel that brings the same internal volume into communication with a hole (8) has not been shown.

In the embodiment shown in FIG. 3, the central layer (3) is recessed over its entire thickness in order to provide the channel (5).

The following example serves to illustrate the invention.

### EXAMPLE

The following example illustrates the assembly of subassemblies intended to form an electrodialyser for the production of sodium hydroxide and hydrochloric acid starting from an aqueous sodium chloride solution (“brine”).

A rectangular sheet of PVC, with sides of 1540 and 1195 mm and a thickness of 10 mm, was placed horizontally and 4 vertical guiding columns 33 mm in diameter were provided on the periphery of the said plate. The orthogonality of the columns and the plate was fully checked. The following components, each provided with four holes 33 mm in diameter intended to receive the guiding columns, were superposed in succession on the sheet:

1. A 0.35 mm thick gasket made of SANTOPRENE® from Monsanto;

2. The constituent components of a separator frame, namely two outer layers made of rigid polypropylene 1 mm in thickness, on either side of a central layer made of SANTOPRENE® elastomer from Monsanto, having a Shore A hardness of 64 and a thickness of 0.6 mm The central layer was recessed according to the invention in order to form a channel 5 mm in width and 60 mm in length;

3. A second 0.35 mm thick gasket made of SANTOPRENE® from Monsanto, the gaskets and the three layers of the frame having the shape of a rectangular fame with dimensions of 1340×1020 mm and having been precoated with a layer of adhesive for plastics; and

4. A SOLVAY®CRA cationic membrane with a thickness of 150 μm and dimensions of 976×1114 mm, surrounded by a rectangular “mount” with external dimensions of 1340×1020 mm and internal dimensions of 982×1120 mm.

After the above operations, corresponding to the stacking of the constituents 1 to 4, an electrodialyser for circulating brine was obtained. These operations were then repeated in order to form the compartment in which the sodium hydroxide is to circulate, by replacing the SOLVAY®CRA membrane with a bipolar membrane obtained by the juxtaposition, carried out under the conditions described in the document WO 01/79335, of a cationic MORGANE CDS membrane (150 μm) with an anionic MORGANE ADP membrane (50 μm). Finally, the same operations were repeated a third time in order to form the compartment in which the hydrochloric acid will circulate, this time by replacing the cationic membrane with a SOLVAY®AW anionic membrane. After the three series of operations, an electrodialysis cell was obtained.

The three series of operations were then repeated ten times in order to form a stack of ten identical electrodialysis cells, constituting a subassembly.

The subassembly was then put under compression and subjected to a sealing test, consisting in introducing water under a pressure of 0.02 bar into all of the thirty compartments and in measuring, after closing the circuits, the time taken for the pressure in the compartments to be reduced by 0.016 bar. This time must be greater than 15 minutes in order for the subassembly to be considered as leaktight. If the subassembly is correctly leaktight, it is packaged as follows. The following items are placed in succession on top of the subassembly, again placed on the sheet of PVC: a first rectangular packing foil, MIL-PRF 1315 produced by TOMOLPACK (comprising an aluminium layer and a polyethylene layer) and a second rectangular PVC sheet, with sides of 1540 and 1195 mm and thickness of 10 mm. The two PVC sheets placed on either side of the subassembly are clamped together and the whole assembly turned upside down The first PVC sheet, now lying on the top of the second, is removed and replaced with ten PTFE straps 1450 mm in length distributed over the long side of the subassembly. A second packaging sheet is finally placed on top of the straps and is welded to the first packaging sheet, maintaining a vacuum of 0.1 bar in the package.

Ten packaged subassemblies were then transported in a conventional manner to a room designed for constructing electrodialysers. The packages were opened, the straps being underneath The ends of the straps were fastened to a metal transporting frame and the ten subassemblies superposed in this way in a very precise manner without any relative displacement of their constituent components, then placed between two electrodes and pressed together.

1-15. (canceled)

16. A compartment for an electrodialysis cell, bounded by two ion-permselective membranes located on either side of a separator frame, wherein the separator frame is formed from an assembly of at least two layers that are profiled so as to leave, between the at least two layers, electrolyte feed channels coming from circulation orifices into an internal volume of the compartment, at least one portion of the walls of the feed channels being formed by internal surfaces of the at least two layers.

17. A compartment according to claim 16, wherein at least one layer is recessed over a portion of its thickness to provide the feed channels after assembly.

18. A compartment according to claim 16, further comprising a central layer between the at least two layers, the central layer being recessed over its entire thickness to provide the feed channels.

19. A compartment according to claim 18, wherein the central layer is made of a material more flexible than that of the at least two layers.

20. A compartment according to claim 16, further comprising a lattice filling substantially an entirety of the internal volume of the compartment.

21. A compartment according to claim 20, wherein the lattice comprises a thick wide-meshed layer located between two thin fine-meshed layers.

22. An electrodialysis cell, comprising at least one compartment according to claim 16.

23. An electrodialyser, comprising at least one electrodialysis cell according to claim 22.

24. A method for mounting an electrolytic device including a plurality of cells involving at least one ion exchange membrane, the method comprising:
separately forming subassemblies each including an assembly of at least two cells; and
joining the subassemblies together between two end walls to form an electrodialyser.

25. A method according to claim 24, wherein the electrolytic device is an electrodialyser comprising at least one compartment.

26. A method according to claim 24, wherein the subassemblies are packaged after they have been formed, then unpacked before being joined together.

27. A method according to claim 26, wherein the packaging is carried out in a vacuum.

28. A method according to claim 26, wherein transport straps are placed in the package under each subassembly.

29. A method according to claim 24, further comprising, between the separately forming and joining, forming intermediate modules of one or more subassemblies, constituent components of the intermediate modules being fastened together by a fastening.

30. An electrodialyser obtained by the method according to claim 29, which comprises a plurality of electrodialysis cells grouped into modules and fastening means for fastening each module together, so as to allow modules to be substituted after the electrodialyser has been assembled.
